(19) United States
(12) Patent Application Publication
(10) Pub. No.: US 2008/0097777 A1
(43) Pub. Date: Apr. 24, 2008

(54) ELECTRONIC DOCUMENT EXECUTION

(75) Inventor: Claudio Daniel Rielo, Arvada, CO (US)

Correspondence Address: HENSLEY KIM & HOLZER, LLC, 1660 LINCOLN STREET, SUITE 3000, DENVER, CO, 80264, US

(73) Assignee: CTM SOFTWARE CORPORATION, Lakewood, CO (US)

(21) Appl. No.: 11/876,512

(22) Filed: Oct. 22, 2007

Related U.S. Application Data
(60) Provisional application No. 60/853,790, filed on Oct. 23, 2006.
(60) Provisional application No. 60/853,702, filed on Oct. 24, 2006.
(60) Provisional application No. 60/936,674, filed on Jun. 22, 2007.

(51) Int. Cl. G06Q 99/00

(52) U.S. Cl. 705/1

(57) ABSTRACT

An electronic document execution system is provided. In one implementation, a method of executing a transaction includes creating a transaction document object populated with transaction document data and incorporating a signature image capture component; capturing a signature image via the signature image capture component of a party to the transaction document; storing the signature image associated with the transaction document object as transaction agreement data; and locking at least a portion of the transaction document data including the signature image responsive to the capturing operation. In another implementation, a system for creating and processing documents for execution includes a server comprising a document repository, the document repository comprising at least one transaction object populated with transaction document data and incorporating a signature image capture component, wherein the server executes the signature image capture component to capture a signature image received, stores the signature image in the document repository with the transaction document data, and locks at least a portion of the transaction document data responsive to capturing the signature image

### CROSS-REFERENCE TO RELATED APPLICATIONS

This application claims the benefit of U.S. provisional application No. 60/853,790, filed 23 Oct. 2006; U.S. provisional application No. 60/853,702, filed 24 Oct. 2006; and U.S. provisional application No. 60/936,674, filed 22 Jun. 2007. Each of these provisional patent applications is hereby incorporated by reference as though fully set forth herein.

### BACKGROUND

a. Field of the Invention

The instant invention relates to electronic document creation and execution.

b. Background

Documents to be executed include, but are not limited to contracts, applications, disclosures, addendums, approvals, and other documents. The documents are typically prepared on a workstation and converted into a hardcopy (e.g., printed out) or a softcopy (e.g., converted to an alternative electronic format such as a portable document format (pdf)) for distribution to one or more individuals for execution. The documents may be distributed by mail, facsimile, electronic mail, or the like. Recipients of the documents execute the document and return it to the originator.

In some systems, the recipients can electronically execute the document. An electronic text signature (e.g.,/James A. Smith/) can be inserted into the electronic document or an image file (e.g., a scanned image of a signature) can be incorporated into the electronic document and the electronically executed document can be forwarded back to the originator or forwarded on to the next individual for execution.

### BRIEF SUMMARY

An electronic document execution system is provided. In one implementation, a method of executing a transaction document is provided. The method includes creating a transaction document object populated with transaction document data and incorporating a signature image capture component; receiving a signature image captured via the signature image capture component of a party to the transaction document; storing the signature image associated with the transaction document object as transaction agreement data; and locking at least a portion of the transaction document data including the signature image responsive to the capturing operation. A signature image may be captured by digitizing an image created by a user on a client via a user interface device or by receiving a signature image file from a client. A signature image, for example, may comprise a signature, initials, or some other identifying mark.

In another implementation, a system for creating and processing documents for execution is provided. The system includes a server comprising a document repository, the document repository comprising at least one transaction object populated with transaction document data and incorporating a signature image capture component, wherein the server executes the signature image capture component to capture a signature image received, stores the signature image in the document repository with the transaction document data, and locks at least a portion of the transaction document data responsive to capturing the signature image.

In another implementation, an electronic document is provided. The system includes a parent document comprising a signature image capture component to capture a signature image received and identifying information specific to a transaction; and a child document related to the parent document by the transaction, wherein the identifying information is automatically propagated from the parent document to the child document, and wherein the signature image capture component is executed to capture a received signature image, stores the signature image associated with the parent document, and locks at least a portion of the parent document responsive to capturing the signature image.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. It should also be understood that, although specific implementations are described herein, the described technology may be applied to other systems.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 shows a block diagram of an example system for preparing and executing electronic documents.

FIG. 2 shows an example flow diagram of a process of preparing and executing an electronic document.

FIG. 3 shows a block diagram of another example system for preparing and executing electronic documents.

FIG. 4 shows an example flow diagram of a process of providing information relating to a transaction to a service provider via a service provider client.

FIG. 5 shows a block diagram of an example system for preparing and executing real estate contract electronic documents.

FIG. 6 shows an example flow diagram of a process of preparing and executing real estate contract electronic documents.

FIG. 7 shows one example of a tool for selecting one or more clauses to be inserted into a real estate document.

FIG. 8 shows an example of a custom addendum form used to enter custom sections to be added to an electronic real estate document.

FIG. 9 shows an example of an automatic deadline tool for creating and inserting deadlines into a real estate document.

FIG. 10 shows an example of a tool for creating a new template.

FIG. 11 shows an example of a calendar date selection tool.

FIG. 12 shows one example of an electronic calendar showing deadlines that have been automatically populated into the calendar.

FIG. 13 shows an example of contract deadline tracking tool.

FIG. 14 shows one example of an electronic document copy tool.

FIG. 15 shows an example of a list of electronic documents that may be copied in whole or in part into a new electronic document.

FIG. 16 shows an example of an electronic message providing one or more links to electronic documents.

FIG. 17 shows one implementation of a portion of a seller property disclosure that can be edited by a seller involved in a real estate contract.

FIGS. 18A and 18B show examples of an execution block of an electronic document through which a party may execute the document.

FIG. 19 shows a confirmation window.

FIG. 20 shows an example of a title order form that may be used by a real estate agent or other party to place an order for title insurance in a real estate transaction.

FIG. 21 shows an example of a document structure for an example transaction.

FIG. 22 shows an example of a document object for an example transaction.

FIG. 23 illustrates an example computing system that can be used to implement the described technology.

### DETAILED DESCRIPTION

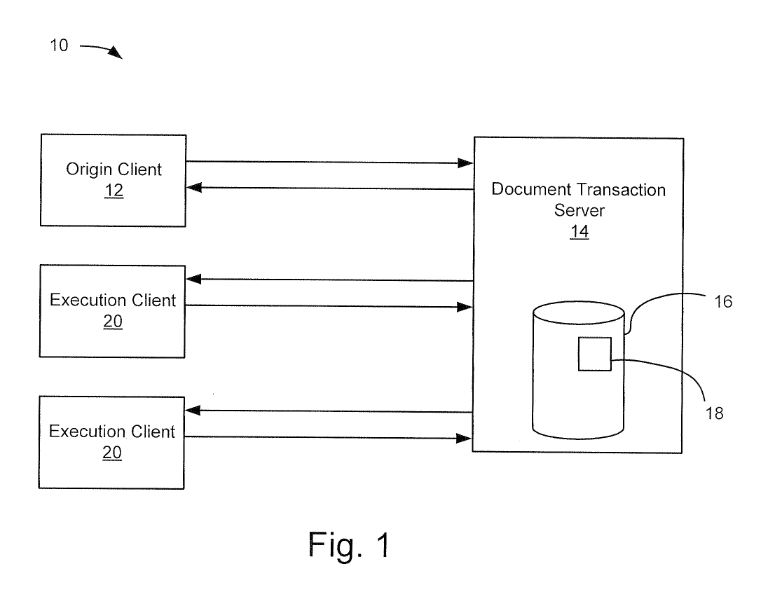

FIG. 1 shows a block diagram of an example system 10 for preparing and executing electronic documents. The system 10 comprises an originating client 12 and a document transaction server 14. The originating client 12 and the document transaction server 14 can be connected over any type of network, such as a local area network, a wide area network, the Internet, or the like. The document transaction server 14 comprises a document repository 16 that stores at least one electronic document 18. The system 10 further comprises one or more execution clients 20 connected to the document transaction server 14 via a network.

A document originator connects to the document transaction server 14 via the originating client 12 to create and edit an electronic document 18 relating to a transaction. The electronic document 18 is stored and maintained on the document transaction server 14 in the document repository 18. When the document originator has created the electronic document 18 and the electronic document 18 is ready for action by a party to edit or execute the electronic document 18, the document transaction server 14 provides access to the electronic document 18 to a party to the transaction via a link transmitted to the party via the execution client 20. The party can access the electronic document 18 on the document transaction server 14 via the link, such as by opening a session with the server via a web browser.

The document transaction server 14 maintains control of the document, but allows remote access to the document either via a secure login to an account or via a link transmitted directly to a party to the transaction. The party can review, revise, or execute the electronic document 18 via the execution client 20 on the server 14. Execution of a document, for example, may include a signature and/or initials in the document. A party, for example, may initial sections (e.g., disclosure obligations or waivers) or pages of a document and sign a signature block of the document. A party may also place his or her initials in a box, that are then propagated throughout the document (e.g., on every page or at certain required locations)

Once a party has executed the electronic document 18, the server locks at least a portion of the electronic document so that it may no longer be changed. In one implementation, for example, a command may be issued to lock the document. In another implementation, the document may be locked via a data field stored in a database.

Other parties may also execute the electronic document after it has been locked, but may not alter the locked contents of the electronic document 18. Thus, the content of the document is locked once it has been executed so that it cannot be altered.

By maintaining the electronic document 18 on the document transaction server 14, the server allows for interactive and real-time updating and control of the electronic document. Once the document has been updated on the server by one party, another party may refresh its connection or establish a new connection to the server to see the revised version of the electronic document 18 on the server. In one implementation, a single instance or version of the document may be controlled by the server. In this implementation, for example, the document is locked once it has been executed and is protected from later alterations. In addition, multiple parties may execute the same document by accessing it on the server. The parties no longer need to forward electronic or hard copies of the document to each of the parties and return revised versions to each party for review. Rather, revision and review of the document can take place in one convenient location on the server. Revision may also be controlled to one or more individuals that are controlling the document. The document originator, for example, may receive comments from at least one party and revise the document in accordance with those comments. In this manner, the document is controlled to prevent unauthorized revisions. In another implementation, for example, any revisions may be monitored and recorded (e.g., by the server). Revisions, for example, may be highlighted and shown (e.g., in a legal black-line format). Further, the document may identify the individual that made each revision.

A party may execute the electronic document 18 via a signature image capture component of the electronic document object. The component executes on the document transaction server 18. In some implementations, the component may further include code that is capable of executing on the execution client 20 to capture an image at the execution client 20 and forward the captured image to the server 18. The signature image capture component allows the server to capture a signature image from a user interface device of the execution client 20 and to store the signature image with the electronic document 18. In another implementation the signature image capture component may capture a signature image by receiving a signature image file uploaded from a client.

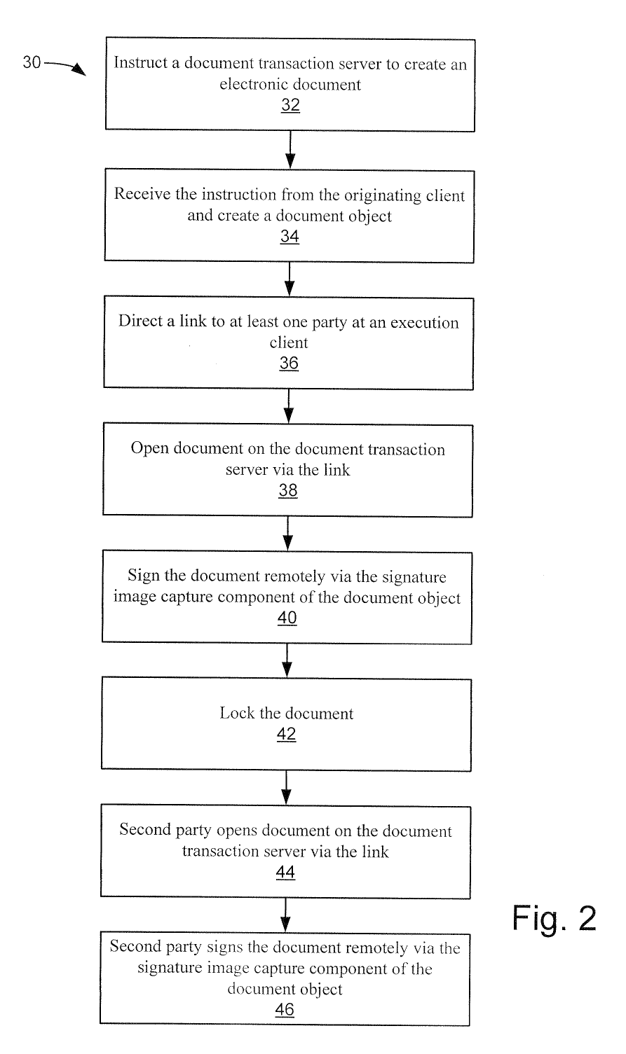

FIG. 2 shows an example flow diagram of a process 30 of preparing and executing an electronic document. In operation 32, an originating client instructs a document transaction server to create an electronic document. The electronic document, for example, may comprise a contract, an application, a disclosure, an addendum, an approval, or another document. The document may be from any number of fields, such as legal, medical, financial or any other field that requires execution. The instruction process may further comprise an authentication operation that allows a user on the originating client to securely access documents in an account. The user, for example, may log into the server to access documents stored in the account.

The document transaction server comprises an application executing on the server that receives the instruction from the originating client and creates a document object in operation 34. The server may include a plurality of components that may be used to create the document object. These components may comprise a plurality of standard document components stored in a library, database, or other storage mechanism, such as in a document repository of the document transaction server. Where the document comprises a contract, for example, the plurality of components may include a plurality of clauses that may be selected by a user on the originating client to assemble the contract. In a real estate contract, for example, the components may comprise a plurality of clauses approved by a real estate commission, other regulatory agency, or another group or individual. Thus, a user on the originating client is able to build a document object by selecting one or more components via the application executing on the document transaction server. Another component that may be selected by the user is at least one executing party and information related to that executing party that is going to execute the document object. In one embodiment, for example, the executing party and related information (e.g., physical address, electronic mail address and/or other contact information) may be stored in an address book on the document transaction server.

A signature image capture component may also be incorporated as a component within the document object. The signature image capture component, for example, may comprise a Flash or other executable component that executes on the document transaction server and/or the execution client to allow a party to execute the document via a user interface device (UID) of the execution client. The party, for example, may use a mouse, mouse pad, signature pad, tablet PC, trackball, touchscreen, stylus, or other user interface device to create a signature image at a location within the document that is captured and stored in the document by the signature image capture component. In another implementation, the signature image capture component may capture a signature image that is uploaded from an execution client (e.g., in an image file). Thus, a signature image may be captured by digitizing an image created by a user on a client via a user interface device or by receiving a signature image file from a client.

In one implementation, depending upon the application, the signature image capture component may further provide a window informing the executing party of the consequences of electronically executing the document and can require the party to consent to the consequences. The component, for example, may inform the party that a signature on a contract is legally binding and require the party to acknowledge his understanding. In a sworn statement, for example, the component may inform the executing party of the consequences of signing a knowingly untrue statement, such as being prosecuted for perjury or the like. The component may also monitor the image to make sure that an acceptable image is received. If the user does not make a readable image (e.g., a short line or dot), the signature image capture component can provide a warning and require the party to execute the document again.

In one embodiment, the application may also allow the user to add other components into the document. These components, for example, may be uploaded to the server from the originating client or may be custom created via the application executing on the server (e.g., entered by the user). In one embodiment, the components may include custom or uploaded clauses that may be added to the document object being created by the application executing on the document transaction server. Another type of component that may be added by the user may comprise uploaded or added by the user at the time of document object creation is executing party and related information (e.g., physical address, electronic mail address and/or other contact information). In one implementation, a text box may allow a user to enter custom sections to be added to the electronic document. The user, for example, may type or cut and paste text into the text box that the application converts into an electronic format to be stored as part of the electronic document.

After the document object has been created and stored in a document repository associated with the document transaction server, the document transaction server directs a link to at least one party at an execution client in operation 36. The document transaction server, for example, may email, instant message, or otherwise direct the link to the at least one party. By transmitting a link to the party instead of transmitting an electronic copy of the document, the document transaction server is able to maintain control of the document and provide real-time updates to the document. Instead of having different versions of the document signed separately or having to be forwarded to individuals sequentially, multiple executing parties may each receive a link that allows them to access the same document on the document transaction server.

An executing party opens the document on the document transaction server via the link in operation 38. A user may click on the link, for example, to open the document in a browser session on the document transaction server. The user thus can review the document remotely from the document transaction server on the execution client. If there are changes to be made, the execution party can request the originating user to alter the document on the document transaction server via the originating client. As soon as the changes have been made, the execution party can refresh the browser session or open a new browser session on the document transaction server to see the updated document in real-time.

The executing party can then execute the document by signing the document remotely via the signature image capture component of the document object in operation 40. The executing party uses a user interface device of the execution client to create an image at a signature block of the document, and the signature image capture component captures the signature. The signature is store within the document object or associated with the document object. Since the document object is stored on the server, the signature stored within or associated with the document object is visible during any subsequent access by another party or the originating party.

Once a party has executed the document and the signature image capture component has captured the image within the document object, the application executing on the document transaction server locks the document in operation 42. The locked document may no longer be changed once it has been executed. In the event that a change needs to be made, a new document is created and the process started over again, but the executed document is protected from alterations.

A second executing party (e.g., in a contract to be executed by multiple parties) that has also received a link opens the document on the document transaction server via the link in operation 44. Again, the second executing party can open the document on the document transaction server via a browser session on an execution client. At this point, since the document has already been executed and a signature of a first party has been captured in the document object, the second executing party can see that the document has already been executed by the first party.

The second executing party can then execute the document using a user interface device on an execution client via the signature image capture component in operation 46. Where more than one party is executing the document, the link sent to each party may be specific to that party and only allow the party to sign the document at a signature block corresponding to that party. Alternatively, more than one signature block instances may be available, and the executing party can simply find the correct signature block by the name associated with the signature block.

Operations 44 and 46 may be repeated as many times as needed until each party has executed the document. By maintaining the document on the document transaction server instead of forwarding electronic copies of the document to the parties, the document is maintained in real-time and the same version of the document can easily be executed by multiple parties.

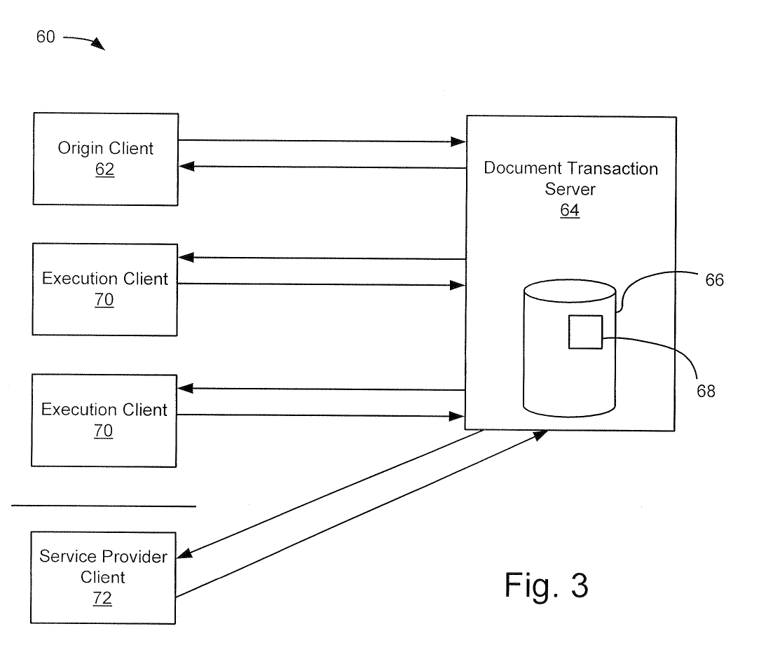

FIG. 3 shows a block diagram of another example system 60 for preparing and executing electronic documents. In the system 60, an originating client 62, at least one execution client 70, and a service provider client 72 are connected to a document transaction server 64. As described above with respect to FIG. 1, the document transaction server comprises a document repository 66 in which at least one electronic document 68 is stored.

The service provider client 70 has access to the document transaction server 64 to provide a service and/or product related to an executed document. The document transaction server 64 forwards a link and/or information related to a transaction or document to the service provider client 70 to request a service provider to provide some type of service or product to the parties. Where the parties are involved in a real estate transaction, for example, the service provider may provide title services, mortgage or loan services, inspection services, or any other services related to the transaction. Where the electronic document is an application, for example, the application may be for credit card, loan, or other services.

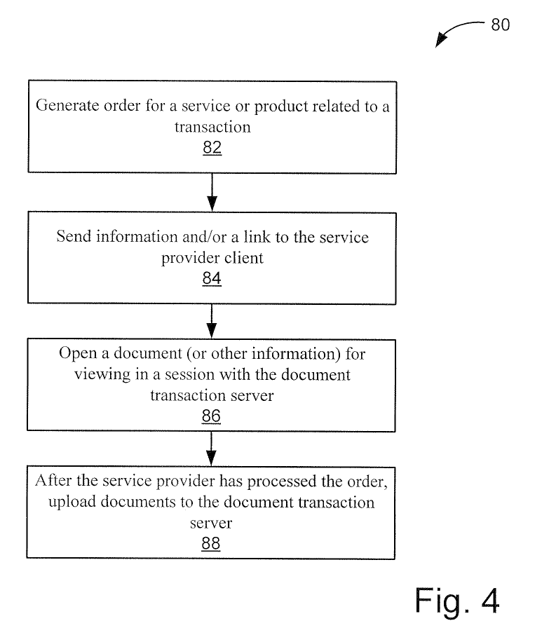

FIG. 4 shows an example flow diagram of a process 80 of providing information relating to a transaction to a service provider via a service provider client. After a document has been executed, an order for a service or product related to a transaction is generated in operation 82. The order, for example, may be generated via a session at an originating client or an execution client and uploaded to a document transaction server, such as via a browser session with the document transaction server. In response, the document transaction server sends information and/or a link to the service provider client in operation 84. As described above, the information and/or the link may be provided in an electronic mail message, an instant message or some other type of electronic communication. Information, for example, may comprise the order for the service or product related to the transaction or may provide information derived from one or more documents stored on the document transaction server. A link may provide access to information or one or more documents stored on the document transaction server and allow the service provider to open or view the documents on the document transaction server.

Where a link has been transmitted to the service provider via the service provider client, the provider client may connect to the document transaction server via the link and open a document (or other information) for viewing in a session with the document transaction server, such as via a browser session, in operation 86. The service provider client can then download information and/or documents from the document transaction server for processing the order.

After the service provider has processed the order, the service provider may upload documents to the document transaction server in operation 88. The service provider, for example, may upload a title policy related to a real estate transaction to the document transaction server via a session with the server. As described above, the service provider may provide any type of service or product related to a transaction involving the documents prepared and executed via the document transaction server. In one implementation, the service provider may upload documents into a document management system to be associated with one or more particular transactions. In this manner, the document may be stored in a convenient location that is associated with a particular transaction.

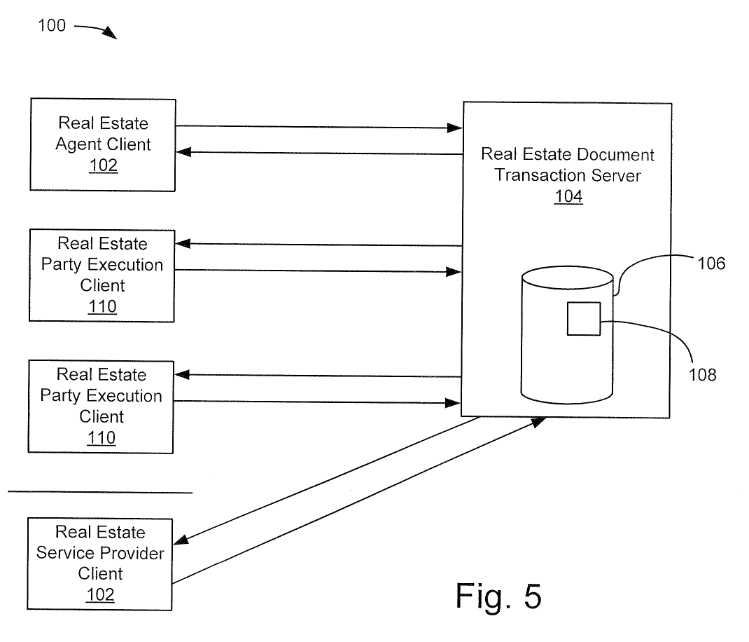

FIG. 5 shows yet another example of a system 100 for preparing and executing real estate electronic documents relating to a real estate transaction. A real estate electronic document is merely one example of an electronic document that may be used within a system for executing an electronic document. Any other field of document may be used within a system for executing an electronic document, such as but not limited to legal, medical, financial or other fields.

The system 100 comprises a real estate agent client 102. A real estate agent using the client 102 connects to a real estate contract transaction server 104 via a network. As described above, the real estate contract transaction server 104 comprises a real estate contract repository 106 that stores at least one real estate contract 108. The real estate contract transaction server 104 can also communicate with one or more executing parties via one or more real estate party execution clients 110. The real estate contract transaction server 104 can also communicate with one or more real estate service providers, such as a title insurance provider and a mortgage broker, via a service provider client 120.

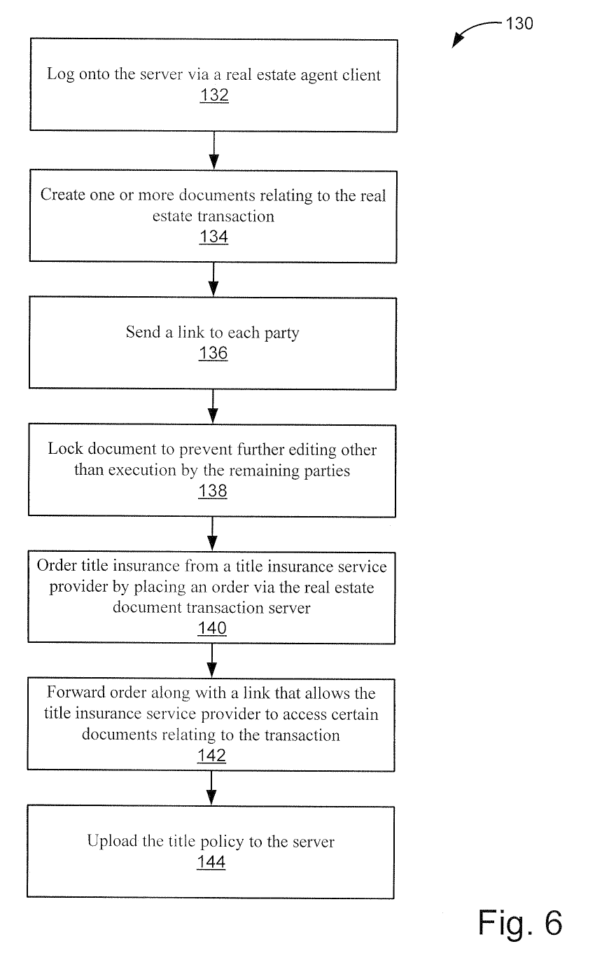

FIG. 6 shows a block diagram of an example process 130 for preparing and executing real estate contract documents via a real estate contract transaction server. A real estate agent, for example, may log onto the server via a real estate agent client in operation 132. The real estate agent, for example, may open a browser on the real estate agent client for communicating with the real estate contract transaction server and log onto an account.

After logging onto the server, the agent may create one or more documents relating to the real estate transaction in operation 134. The documents, for example, may comprise a parent contract, an offer term sheet, a disclosure statement, an appraisal, an extension, a disclaimer, or any other type of document related to or useful in a real estate transaction.

As described above, the real estate agent or another party may select clauses or forms (e.g., forms approved by a real estate commission or regulating authority) from the server. The agent may also generate custom components to be incorporated in an electronic document for the transaction. The custom components, for example, may comprise a custom addendum or disclosure. The agent may upload these addendums or create them on the server via a browser session. In one embodiment, for example, the agent may cut and paste a custom component into a field of a web page provided by the server. The agent may also incorporate a signature image capture component within a document object of one or more documents to be executed by a party to the real estate transaction.

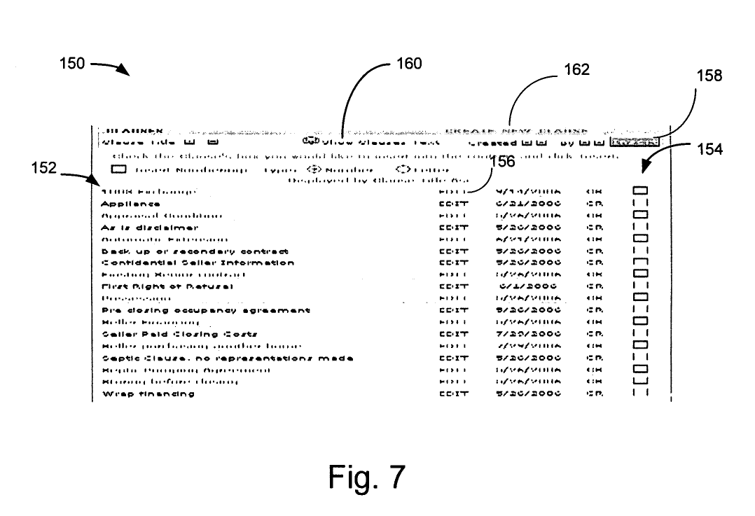

FIG. 7, for example, shows one example of a tool 150 for selecting one or more clauses to be inserted into a real estate document. In the tool 150, a list of clauses 152 is provided from which a real estate agent may select one or more of the clauses for insertion into the real estate document. The real estate agent, for example, may select one or more of the clauses by checking the boxes 154 corresponding to the desired clause(s). The real estate agent may also edit one or more of the clauses by selecting the “EDIT” link 156 corresponding to the desired clause(s). After all of the desired clause(s) have been selected, the real estate agent may incorporate those clause(s) into the real estate document by selecting the “INSERT” box 158. In one implementation, the real estate agent may also view the full text of the clauses by selecting the “Show Clauses Text” link 160 or by selecting on an individual clause listing. The real estate may also create and save a new clause by selecting the “Create New Clause” link 162. The new clause may then be accessed through the tool 150 for future documents.

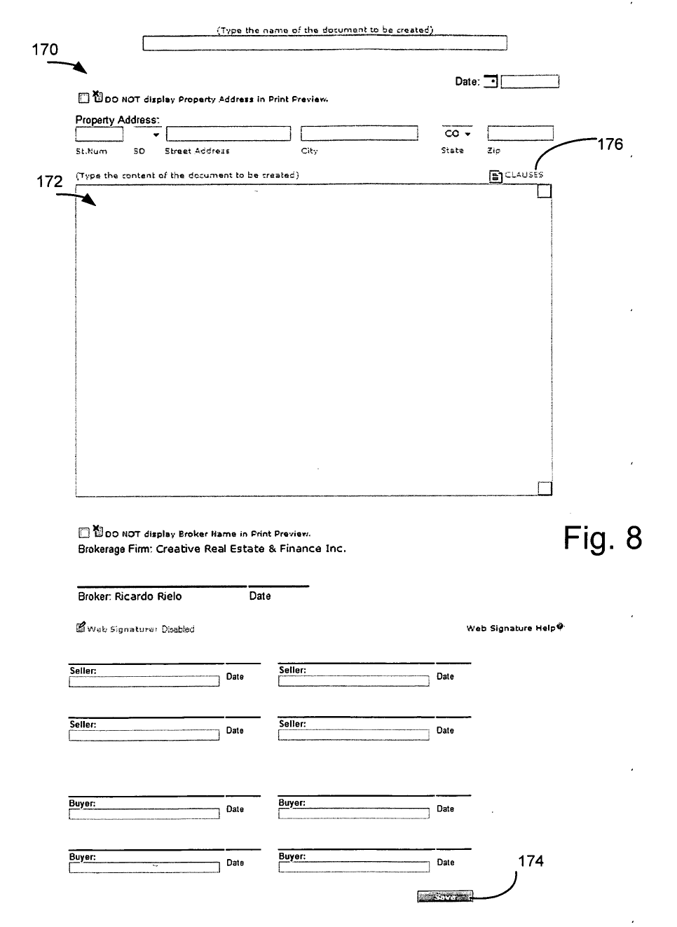

FIG. 8 further shows an example of a custom addendum form 170 that may be used to enter custom sections to be added to an electronic real estate document. The real estate agent, for example, may type or cut and paste text into a text box 172. After the text has been added to the text box 172, the real estate agent can save it as an addendum or as an integral part of a real estate document by selecting the “Save” link 174 that the application converts into an electronic format to be stored as part of the electronic document. In this manner, a text document can be easily converted to an electronic format in which it can be accessed and executed remotely via a server. A real estate agent, for example, can create an electronic document from a text document, send a link to the document to a party, and the party can access the document in real-time on the server via the link. The party can also remotely execute the addendum electronic document. In addition, the electronic document may be interactive in that any changes made to the document can be accessed by refreshing a link or opening a new link. In one implementation, a real estate agent can add pre-selections of clauses (e.g., in a disclosure) as indicated by a party to the contract directly into the text box, such as placing an “X” or another indication next to the particular clauses that are to be selected. The real estate agent can also select text from the clauses discussed above with respect to FIG. 7 to be inserted into the text box of the addendum form 170 by selecting the “Clauses” link 176.

In one embodiment, the electronic documents related to a real estate transaction include deadlines by which certain events are to occur. These deadlines, for example, may include a date by which the buyer must perform a house inspection, a date for opting out of the contract based upon items found in an inspection, a date for depositing earnest money with the seller's agent, and a closing date. An automatic date calculation tool, for example, may also be used for automatically determining whether a particular schedule is feasible. The tool, for example, can be used to determine whether the closing date falls on a holiday or weekend or otherwise conflicts with a schedule of an agent or another party. The application can also allow the agent to create and save templates for different closing scenarios, such as but not limited to 30 day closing, 45 day closing, 30 day mutual execution of closing (MEC), and the like that can be automatically populated into the electronic documents when a preset scenario is selected during document creation.

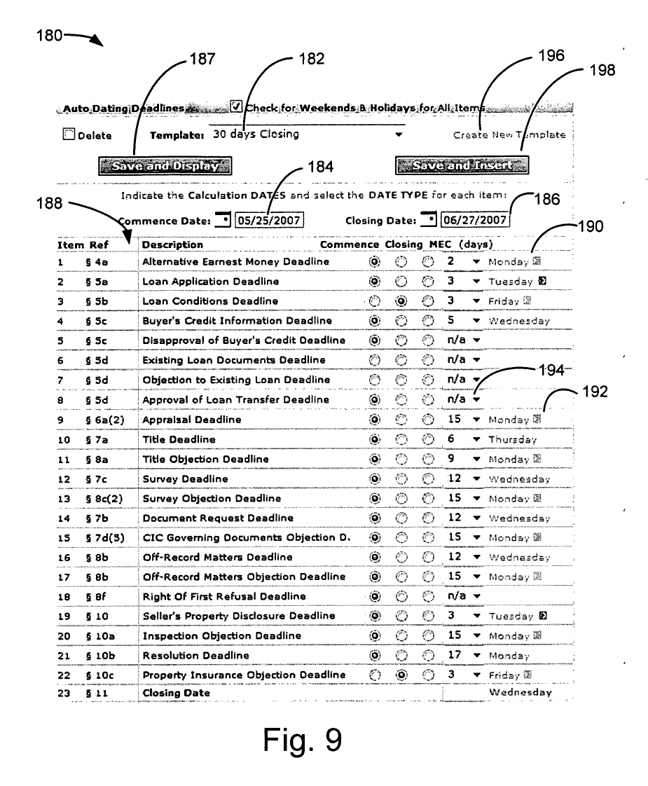

FIG. 9 shows an example of an automatic deadline tool 180 for creating and inserting deadlines into a real estate document. The tool 180 includes a menu 182 for selecting a template that can be used to automatically select deadlines based upon a predetermined template. A template, for example, may provide one or more rules for determining deadlines based upon a contract commence date 184, a closing date 186, or the like. A real estate agent, for example, may select a template and enter a contract date 184 and a closing date 186. When the agent selects a “Save and Display” link 187, the tool 180 automatically determines dates for one or more deadlines 188 based upon the rules of the selected template and displays them on the screen for the agent to review.

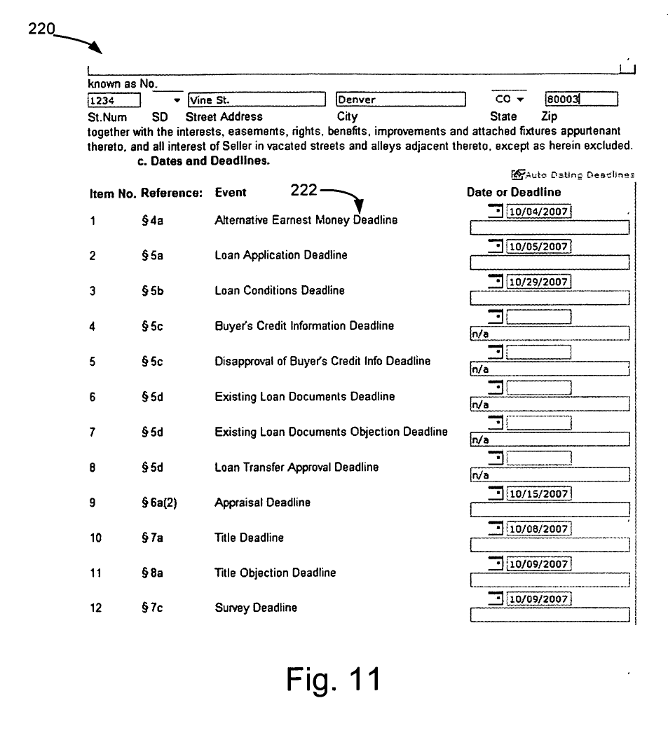

In one particular implementation, the tool 180 may also identify conflicts and adjust the automatically selected deadlines to avoid those conflicts. The conflicts, for example, may include weekends, holidays, or conflicts with a schedule of a real estate agent or party (e.g., via an electronic calendar entry of the agent or party). Where the template would otherwise create a conflict, for example, the tool 180 can adjust the date to fall on another date. In the implementation of FIG. 9, for example, the tool may identify the day of the week 190 for each deadline. The tool 180 may also identify where the date has been changed to clear a conflict, such as via an icon 192. The icon 192, for example, may identify where a day was moved from a holiday or a weekend. The real estate agent may also override one or more of the automatically selected deadline dates, such as via a pull-down menu 194 or by changing the contract commence date 184 or closing date 186. The real estate agent may also create a new template by selecting the “Create New Template” link 196. Once the deadlines are acceptable, the real estate agent may save and/or insert these dates into a real estate document by selecting the “Save and Insert” box 198. FIG. 11, for example, shows an example of a list of dates or deadlines 222 that have been added into an electronic document 220, such as via the automatic deadline tool 180 described above.

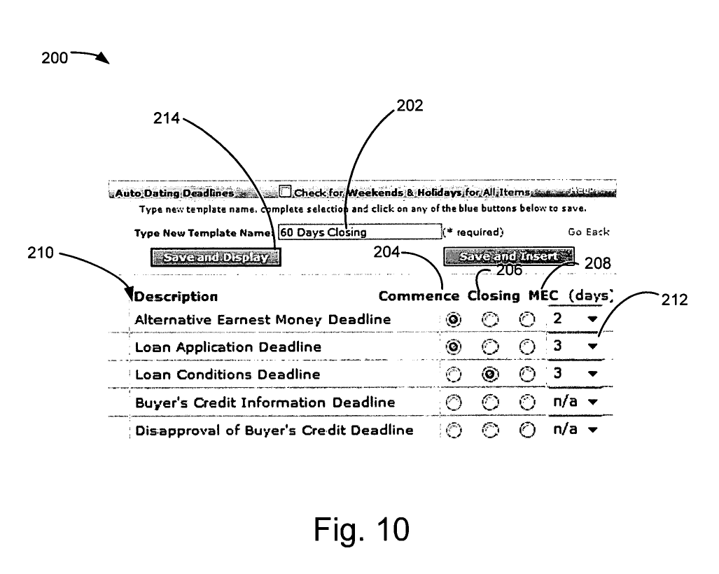

FIG. 10 shows an example of a tool 200 for creating a new template. In the tool 200, an agent may designate a name for the template in text box 202. The agent can also identify rules for calculating deadlines for that particular template. In the implementation shown in FIG. 10, for example, the agent can select rules to calculate the deadline from a contract commence date 204, a contract closing date 206, or a mutual executed agreement (MEC) date 208 for a selection of deadlines 210. The agent can also select a number of days 212 from one of those dates, such as via pull-down menus or text entry. In one implementation, for example, a deadline may be calculated by the selected number of days forward from a contract commence date 204, backwards from a contract closing date 206, or forward from a mutual executed agreement (MEC) date. Once the agent has completed the template, the agent may save the template by selecting the “Save and Display” box 214. The saved template may then be selected from the menu 182 shown in FIG. 9.

In one implementation, for example, an electronic calendar may also be automatically generated including dates or deadlines from an electronic document. In one implementation, for example, at least one of the dates or deadlines of an electronic document are automatically populated to the electronic calendar. The electronic calendar, for example, may comprise a transaction-specific calendar that includes dates or deadlines for a specific transaction. In a real estate transaction, for example, a real estate agent may direct a link to a party of the transaction via which the party may see a real-time interactive calendar specific to the transaction. By accessing the calendar via the link, the party may see an up-to-date calendar each time that party selects the link or refreshes a browser window for that link. The electronic calendar may also include deadlines for an individual across multiple transactions. An agent or party to multiple real estate transactions may have access to an electronic calendar that includes all the deadlines of interest for that individual. The agent, for example, may select from a list of deadlines or other dates 222 to be populated into an electronic calendar. These dates or deadlines, for example, may be automatically populated, such as by the automatic deadline tool 180 described above with respect to FIG. 11, or may be added directly into the calendar date selection tool 220. The agent may then select which of these deadlines are to be populated into an electronic calendar.

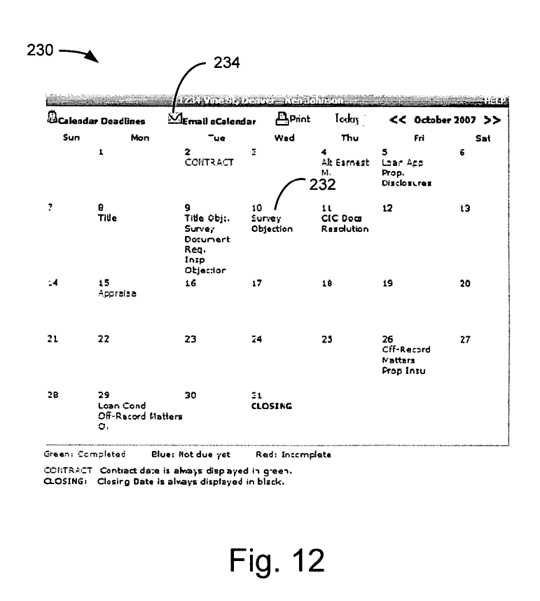

FIG. 12, for example, shows one example of an electronic calendar 230 showing deadlines 232 that have been automatically populated into the calendar. In the particular implementation shown in FIG. 12, the calendar may include color or other indications showing a status of one or more of the entries in the calendar. In one implementation, for example, completed deadlines may be indicated in green text, incomplete or past-due deadlines in red text, and deadlines not yet due in blue text. The agent or other party may also send a link to the calendar to another party, such as by electronic mail or instant messaging, by clicking on the “Email Calendar” link 234. The electronic calendar may also provide for reminder messages that may be sent to an individual either when the deadline is due or a fixed or alterable amount of time prior to the deadline.

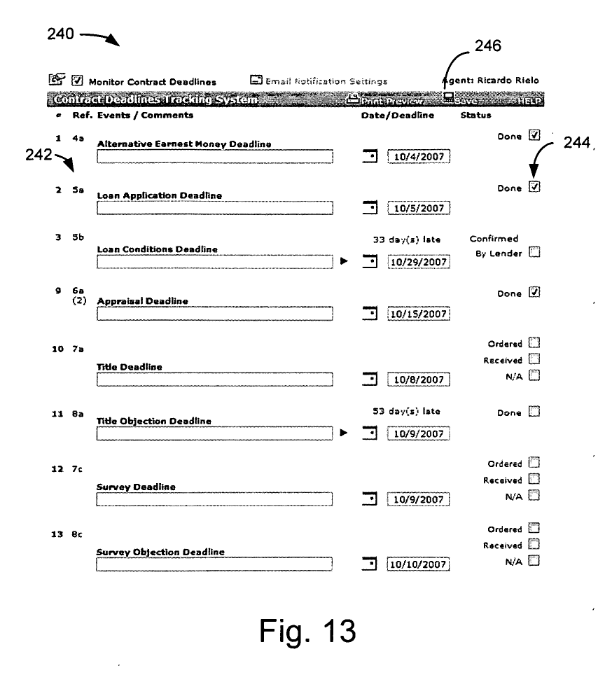

FIG. 13 shows an example of contract deadline tracking tool 240. An agent or party may update the status of one or more deadlines 242 through the status boxes 244. Once a status of one or more of the deadlines has been updated, the agent may select the “Save” link 246 and is returned to the calendar shown in FIG. 12. A change in status of one or more of the deadlines may be shown in the calendar, such as by a change in color or by another status indicator.

In one implementation, the document originator may copy all or part of an existing real estate document to save time in creating a new document. For example, if a previous document has been locked because it has already been executed by a party but the terms have changed slightly, a real estate agent can copy the terms of the locked document into a new live document that can then be updated to conform to the change in terms. Similarly, if new transaction is related to an existing electronic document, some of the information for the new transaction may be automatically populated into a new electronic document. For example, if an existing client has another transaction, information from a previous electronic document that may be copied may include the client information, property information (if it relates to the same property), favored terms, or the like.

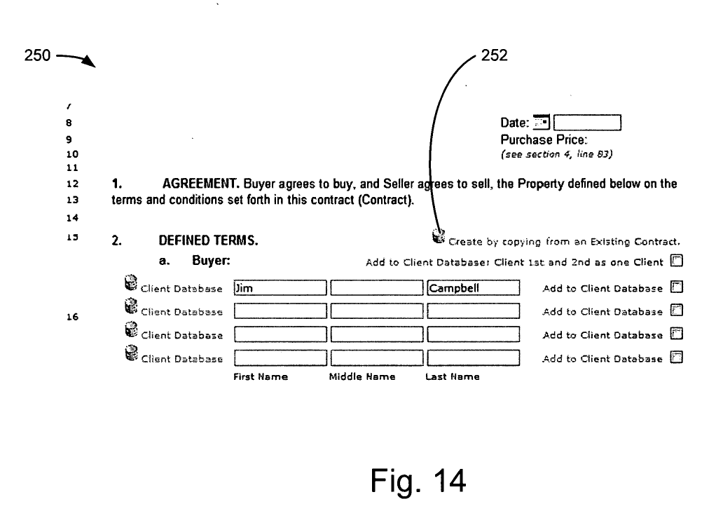

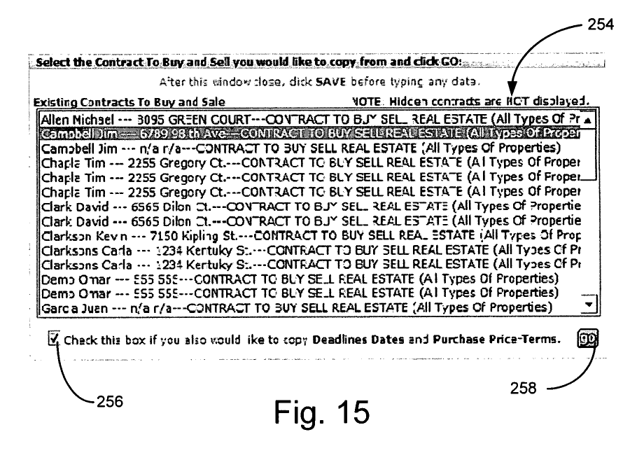

FIG. 14, for example, shows one example of an electronic document copy tool 250. The electronic document copy tool 250. As shown in FIG. 14, the electronic document copy tool 250 may be accessed by selecting a “Create by copying from an Existing Copy” link 252 when an agent is creating a new electronic document, such as a real estate contract. After selecting this link, the electronic document copy tool 250 directs the agent to a list of existing electronic documents 254 shown in FIG. 15.

In the example shown in FIG. 15, the list 254 comprises a list of existing contracts to buy and sell real estate, but one skilled in the art would recognize that any type of existing electronic documents may be used. The agent selects an electronic document from which to copy from the list 254. In one implementation, this electronic document may be copied in whole or in part. In a real estate contract to purchase real estate, for example, an entire real estate contract may be copied including all the terms, deadlines, purchase price, and the like. In another implementation, the general terms of the contract may be copied without transaction-specific information.

If the agent would like to copy particular information within the existing document, such as transaction-specific information, the agent may select one or more box 256 corresponding to that particular information. In the implementation of FIG. 15, for example, a real estate agent may select box 256 to copy deadline dates and purchase price and terms from an existing real estate contract into a new contract. After the electronic document to copy has been selected along with any particular information that is to be copied, the real estate agent can select the “Go” link 258 to copy information from the existing electronic document into the new electronic document being created.

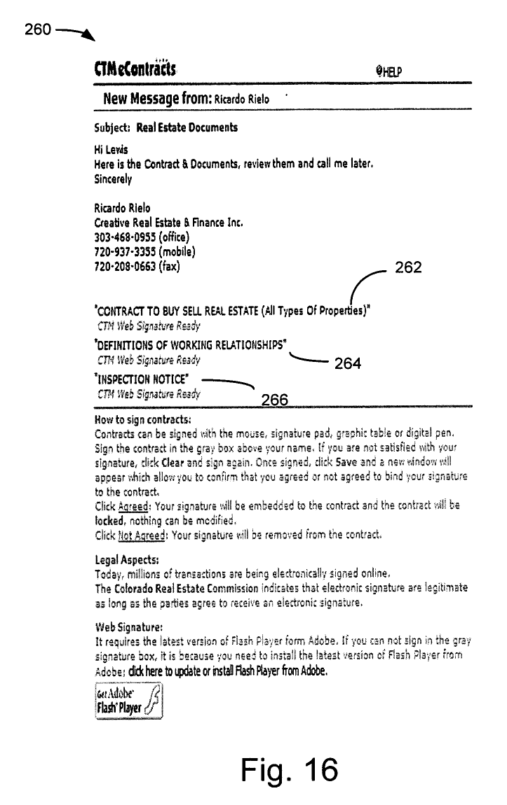

FIG. 16 shows an example of an electronic message 260 that may be received by a buyer or seller. The electronic message includes three links 262, 264, and 266 to electronic documents that are ready for execution. A parent contract to buy and sell real estate may be accessed by the buyer or seller clicking the link 262. The parent contract, for example, could be brought up on the buyer or seller's screen via a web browser window. The buyer or seller may review the document in this web browser window. If changes are to be made, the buyer or seller may call the real estate agent and request changes to the contract. In some implementations, the buyer or seller may make changes to the contract. Security applications may be used to prevent direct modifications to the contract by the buyer or seller or to track and identify any changes to the contract made by the buyer or seller. Other electronic documents, such as a definitions document may be accessed via link 264 and an inspection notice may be accessed via link 266.

Before the documents are to be executed, various documents may be filled in by a party to the transaction instead of the real estate agent. In such an embodiment, for example, the real estate agent may prepare the documents with the exception of certain schedules or information to be added by one or more of the parties to the transaction. A seller, for example, may add information into a standard real property disclosure statement, and a buyer may fill out an inspection notice along with a request to fix defects found in the inspection or for allowances to cover the cost of fixing those defects.

The seller, for example, may receive an electronic message including a link to a disclosure statement document that needs to be filled out. The disclosure statement document can be pre-populated with data entered by the real estate agent (e.g., property address and name of the seller). When the seller clicks on the link received in the electronic message, the disclosure statement document is opened on the server and accessed by the seller via a client over a network, such as the Internet. The seller can fill in the required information and save the document for later execution along with the rest of the electronic real estate documents or can electronically sign the document (e.g., via a signature image capture component of the document object) at which point it is locked to prevent future editing and saved in a document repository of the real estate document transaction server. A buyer may similarly fill out forms on the server and save them to the server. As described above, by maintaining the documents on the server, these edits are viewable in real-time by the real estate agent or the parties once the edited version is saved to the server.

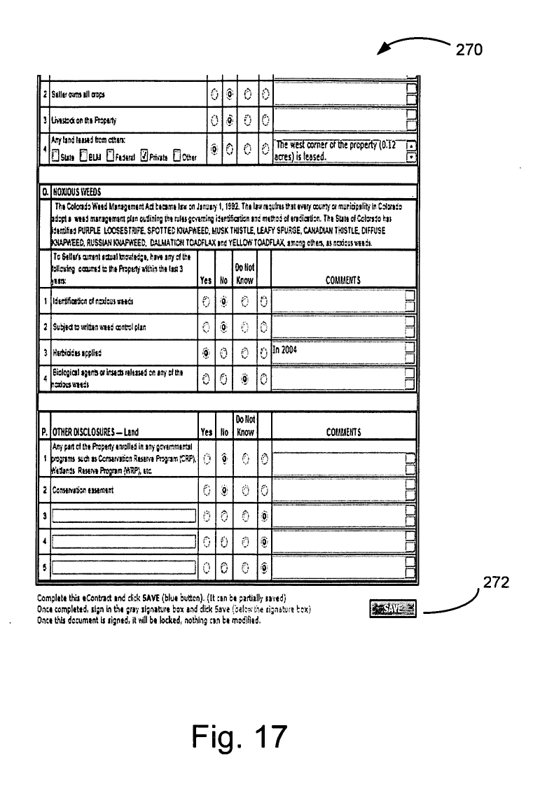

FIG. 17 shows one implementation of a portion of a seller property disclosure 270 that can be edited by a seller involved in a real estate contract. After a real estate agent has created the disclosure 270 on a server, the server can send a link in a message to the seller indicating the property disclosure is complete and ready to be filled out. The seller can access the disclosure 270 on the server via the link as discussed above and fill out the disclosure 270. In one implementation, for example, the seller may fill out a portion of the disclosure and save it as a work in progress by selecting the “Save” box 272. Once the seller's changes have been saved, the seller may access the updated version later via the same link used to access the disclosure the first time. Once the seller has completed the disclosure for 272, the seller may execute the document as described above. The disclosure 270 may then be locked and saved in a document management system for a particular real estate transaction. The seller property disclosure 270 shown in FIG. 17 is merely one type of document that may be edited directly by a party to a transaction.

As shown in FIG. 6, once all the documents are finalized and ready for execution, the server sends a link to each party in operation 136. The parties then use that link to access the documents to be signed on the server as described above. The documents may be executed via a signature image capture component of the document image. After one of the parties has executed the documents, the documents are locked to prevent further editing other than execution by the remaining parties in operation 138.

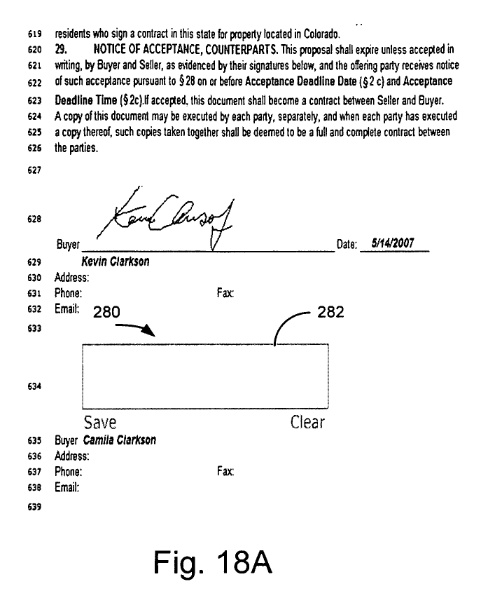

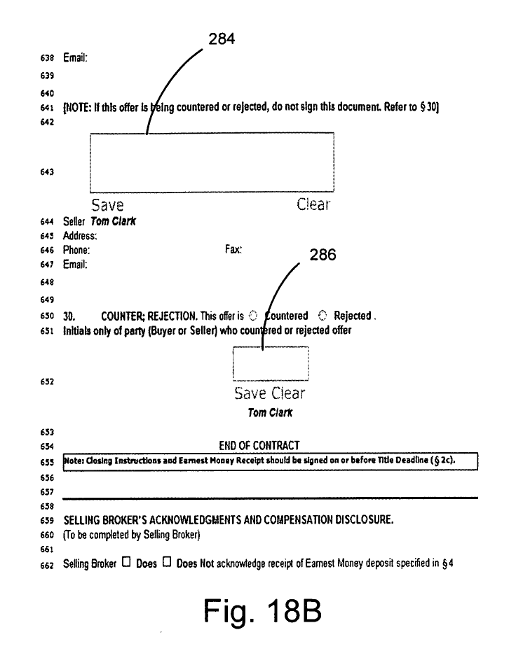

FIG. 18A shows an example of an execution block 280 of an electronic document through which a party may execute the document. As shown in FIG. 18A, the execution block 280 includes an execution window 282 through which a party can execute an electronic document. The party can use a user interface device, such as a mouse, to execute the document at the execution block 280. A signature image capture component, for example, may be used to capture an image of the party's execution signature to be associated with the electronic document on the server. FIG. 18B shows another example of an execution block of an electronic document in which a party can execute in a signature block 284 and/or an initial block 286. In one implementation, for example, the party's signature in signature block 284 may be used in a signature block of the electronic document, while the initials in initials block 286 can be automatically propagated to each page of the electronic document and/or to locations within the electronic document where the initials may be required.

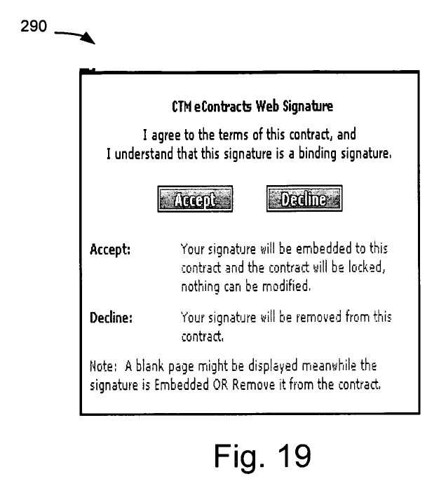

FIG. 19 shows a confirmation window 290. The confirmation window is an example of a confirmation that requests a party to confirm that he is executing a binding document and that the document will be locked upon the execution being confirmed.

As shown in FIG. 6, the real estate agent or other party can also order other services or products related to a particular transaction. The agent or other party, for example, may order title insurance, homeowner's insurance, submit a loan application, or order another service or product related to a transaction. Title insurance, for example, may be ordered from a title insurance service provider by placing an order via the real estate document transaction server in operation 140. The server forwards the order along with a link that allows the title insurance service provider to access certain documents relating to the transaction in operation 142. The title insurance processes the order and uploads the title policy to the server in operation 144. The uploaded title insurance policy can then be stored in the server document repository along with the other documents related to the particular real estate transaction.

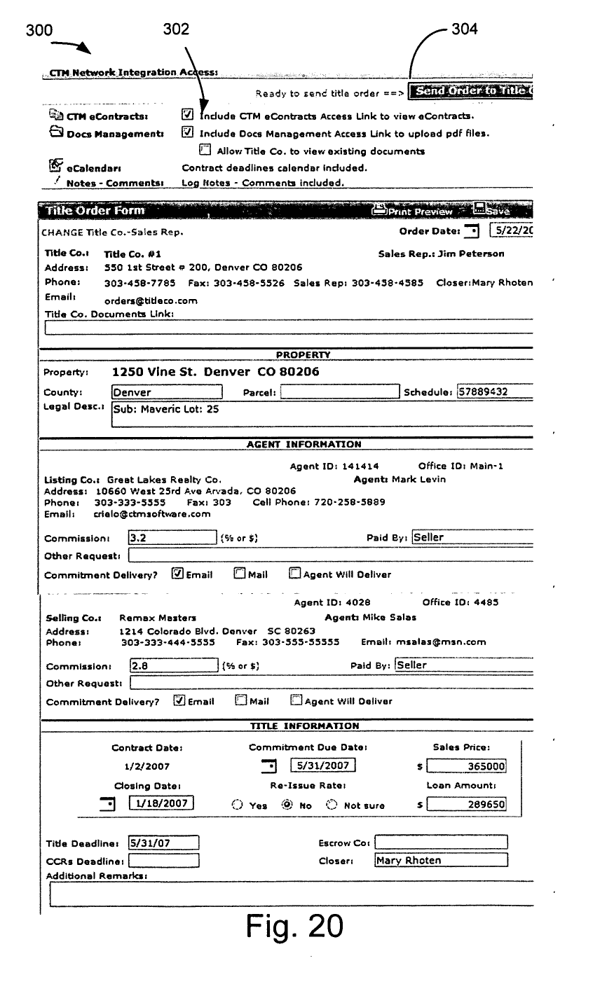

FIG. 20 shows one example of a title order form 300 that may be used by a real estate agent or other party to place an order for title insurance in a real estate transaction. The real estate agent, for example, can fill out the title order form 300 and send the form to a title insurance service provider. In one implementation, for example, the agent may select particular documents from a document management system specific to a real estate transaction that can be provided to the title insurance service provider by selecting one or more of document selection boxes 302. When the agent has completed the order form, the agent may forward the order along with a link to one or more documents that may be used by the title insurance service provider to prepare a title insurance policy by selecting a “Send Order to Title Co.” link 304.

The title insurance company then receives the order, such as in an electronic message. The order includes one or more links to documents that the company can use in preparing a title insurance policy. In addition, the message may contain a link through which the title insurance service provider can upload the any documents, such as a title insurance policy, into an account or a document management specific for a specific real estate transaction. In this manner the policy is then placed in a convenient location for a specific transaction and is readily accessible by a real estate agent or a party to the transaction. In another implementation, the title insurance service provider may simply transmit an electronic or hard copy of the policy to the agent to be placed in the file.

Similarly, orders placed by the real estate agent or parties may be forwarded to other service providers. For example, the buyer may apply for a mortgage from a mortgage broker in a similar manner.

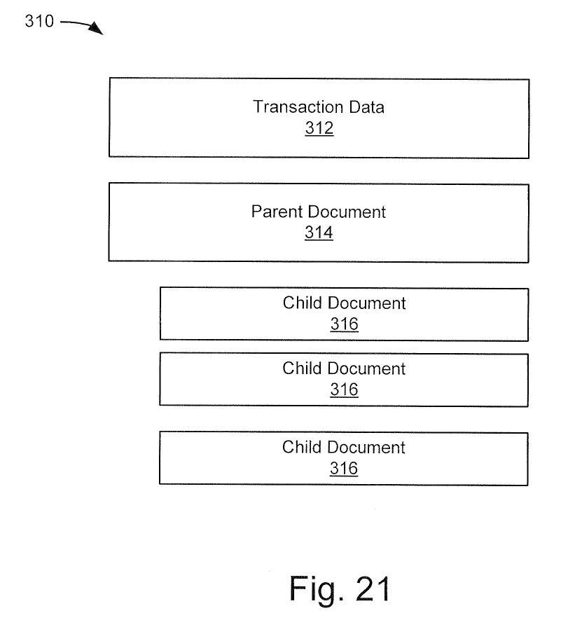

FIG. 21 shows an example of a document structure 310 that may be prepared and stored on a document transaction server. The document structure 310 comprises a transaction data 312, a parent document 314 and a plurality of child documents 316. The transaction data 312, for example, may be stored in a table or database and keeps the transaction-specific data in a single location so that it may be easily updated without having to go through each and every document related to a transaction.

As shown in FIG. 21, the documents may be organized in a hierarchical manner under the single parent document 314. The parent document 314, for example, may be populated from the transaction data and used to populate related child documents 316 for the transaction. Thus, information can be changed in the parent document and the changes populated to the child documents without having to edit each individual document every time any data changes.

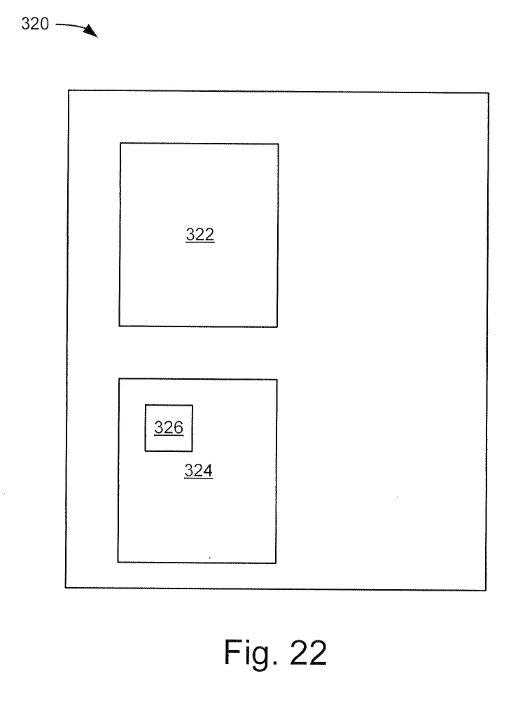

FIG. 22 shows an example of a document object 320 for an example transaction. The document object 320 includes transaction data 322 and a signature image capture component 324. The signature image capture component 324 captures a signature image 326 from a party executing an electronic document. The signature image capture component 324 is a component of the electronic document object 320. The signature image capture component 324 may include code completely within the document object 320 or may include one or more calls to other components that are incorporated by reference within the document object 320. The calls, for example, may reference .NET components, DLL components, or other components to perform one or more functions of the signature image capture component 324.

In one implementation, the signature image capture component 324, for example, may comprise a Flash or other executable component that executes on the document transaction server and/or the execution client to allow a party to execute the document via a user interface device (UID) of the execution client. A Flash window for example, may be used to capture a signature image and create an image file for the captured signature. The party, for example, may use a mouse, mouse pad, signature pad, tablet PC, trackball, touchscreen, stylus, or other user interface device to create a signature image at a location within the document that is captured and stored in the document by the signature image capture component. In another implementation, the signature image capture component may capture a signature image that is uploaded from an execution client (e.g., in an image file). The captured signature image 326 associated with the document object 320 is stored as transaction data 322, and the document object 320 locks at least a portion of the transaction data responsive to the capture of the signature image 326.

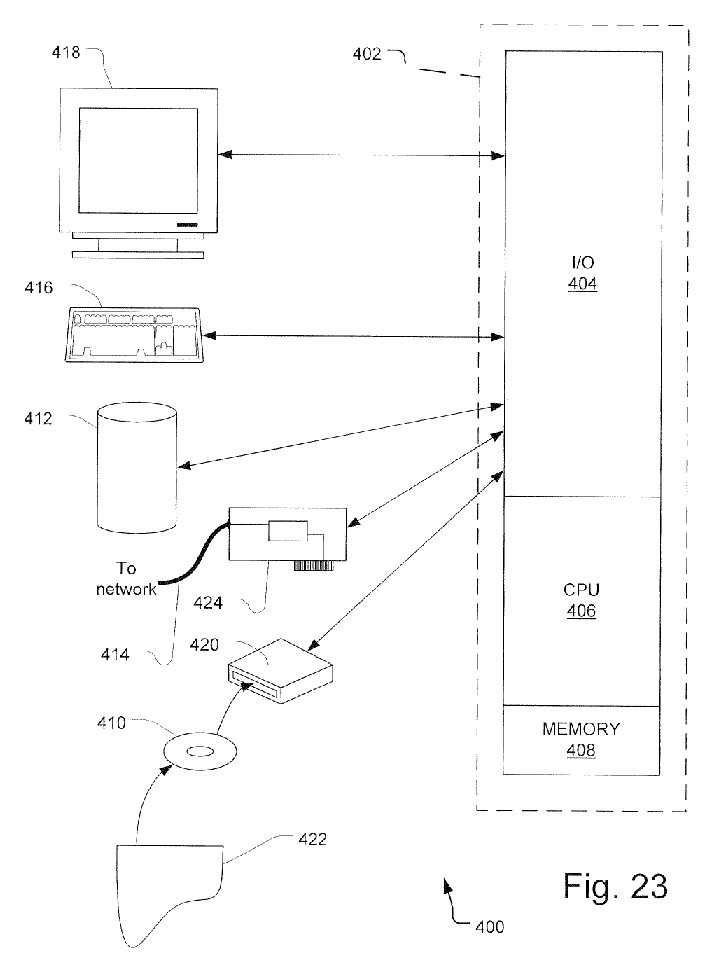

FIG. 23 illustrates an example computing system that can be used to implement the described technology. A general purpose computer system 400 is capable of executing a computer program product to execute a computer process. Data and program files may be input to the computer system 400, which reads the files and executes the programs therein. Some of the elements of a general purpose computer system 400 are shown in FIG. 23 wherein a processor 402 is shown having an input/output (I/O) section 404, a Central Processing Unit (CPU) 406, and a memory section 408. There may be one or more processors 402, such that the processor 402 of the computer system 400 comprises a single central-processing unit 406, or a plurality of processing units, commonly referred to as a parallel processing environment. The computer system 400 may be a conventional computer, a distributed computer, or any other type of computer. The described technology is optionally implemented in software devices loaded in memory 408, stored on a configured DVD/CD-ROM 410 or storage unit 412, and/or communicated via a wired or wireless network link 414 on a carrier signal, thereby transforming the computer system 400 in FIG. 23 to a special purpose machine for implementing the described operations.

The I/O section 404 is connected to one or more user-interface devices (e.g., a keyboard 416 and a display unit 418), a disk storage unit 412, and a disk drive unit 420. Generally, in contemporary systems, the disk drive unit 420 is a DVD/CD-ROM drive unit capable of reading the DVD/CD-ROM medium 410, which typically contains programs and data 422. Computer program products containing mechanisms to effectuate the systems and methods in accordance with the described technology may reside in the memory section 404, on a disk storage unit 412, or on the DVD/CD-ROM medium 410 of such a system 400. Alternatively, a disk drive unit 420 may be replaced or supplemented by a floppy drive unit, a tape drive unit, or other storage medium drive unit. The network adapter 424 is capable of connecting the computer system to a network via the network link 414, through which the computer system can receive instructions and data embodied in a carrier wave. Examples of such systems include Intel and PowerPC systems offered by Apple Computer, Inc., personal computers offered by Dell Corporation and by other manufacturers of Intel-compatible personal computers, AMD-based computing systems and other systems running a Windows-based, UNIX-based or other operating system. It should be understood that computing systems may also embody devices such as Personal Digital Assistants (PDAs), mobile phones, gaming consoles, set top boxes, etc.

When used in a LAN-networking environment, the computer system 400 is connected (by wired connection or wirelessly) to a local network through the network interface or adapter 424, which is one type of communications device. When used in a WAN-networking environment, the computer system 400 typically includes a modem, a network adapter, or any other type of communications device for establishing communications over the wide area network. In a networked environment, program modules depicted relative to the computer system 400 or portions thereof, may be stored in a remote memory storage device. It is appreciated that the network connections shown are exemplary and other means of and communications devices for establishing a communications link between the computers may be used.

In an exemplary implementation, a document creation module, an link generating module, an access module, an execution module, a locking module, and other modules may be incorporated as part of the operating system, application programs, or other program modules. Document objects, signature capture components, document transaction data, and other codes and data may be stored as program data in memory 408 or other storage systems, such as disk storage unit 412 or DVD/CD-ROM medium 410.

The present specification provides a complete description of the methodologies, systems and/or structures and uses thereof in example implementations of the presently-described technology. Although various implementations of this technology have been described above with a certain degree of particularity, or with reference to one or more individual implementations, those skilled in the art could make numerous alterations to the disclosed implementations without departing from the spirit or scope of the technology hereof. Since many implementations can be made without departing from the spirit and scope of the presently described technology, the appropriate scope resides in the claims hereinafter appended. Other implementations are therefore contemplated. Furthermore, it should be understood that any operations may be performed in any order, unless explicitly claimed otherwise or a specific order is inherently necessitated by the claim language. It is intended that all matter contained in the above description and shown in the accompanying drawings shall be interpreted as illustrative only of particular implementations and are not limiting to the embodiments shown. Changes in detail or structure may be made without departing from the basic elements of the present technology as defined in the following claims.

What is claimed is:

1. A method of executing a transaction document, the method comprising:
creating a transaction document object populated with transaction document data and incorporating a signature image capture component;
receiving a signature image captured via the signature image capture component to the transaction document;
storing the signature image in association with the transaction document object as transaction document data; and
locking at least a portion of the transaction document data including the signature image responsive to the capturing operation.

2. A method according to claim 1 further comprising receiving the transaction document data from a client.

3. A method according to claim 1 further comprising communicating access to the transaction document object via a link.

4. A method according to claim 3 wherein the link is directed to a specified party to a transaction.

5. A method according to claim 4 wherein an instance of the signature image capture component is created specific to the link for the specified party.

6. A method according to claim 1 wherein the transaction document data comprises a selection of predefined contract clauses.

7. A method according to claim 1 wherein the transaction document data comprises customizable contract clauses.

8. A method according to claim 1 wherein the transaction document data comprises a plurality of party identifiers.

9. A method according to claim 8 wherein the document object comprises an instance of a signature image capture component for each of the plurality of party identifiers.

10. A method according to claim 1 further comprising generating an order for a service or product related to a transaction.

11. A method according to claim 10 wherein the order is communicated to a provider and access to at least a portion of the transaction document data is provided via a link.

12. A method according to claim 11 further comprising receiving a document from the provider in response to the order.

13. A method according to claim 1 wherein the transaction document data comprises date data that is automatically populated into an electronic calendar.

14. A method according to claim 1 wherein the transaction document data comprises text data incorporated into the electronic document via an addendum tool.

15. A method according to claim 1 wherein the transaction document data comprises a parent document and at least one child document.

16. A method according to claim 15 wherein changes to data in the parent document propagate to the at least one child document.

17. A method according to claim 1 wherein the transaction document comprises an agreement.

18. A method according to claim 1 further comprising altering the transaction on a client before the capturing operation.

19. A method according to claim 1 wherein the signature image is embedded in the transaction document.

20. A method according to claim 1 wherein data from the transaction document is automatically ported to an electronic document.

21. A system for creating and processing documents for execution, the system comprising:
a server comprising a document repository, the document repository comprising at least one transaction object populated with transaction document data and incorporating a signature image capture component,
wherein the server executes the signature image capture component to capture a signature image received, stores the signature image in the document repository in association with the transaction document data, and locks at least a portion of the transaction document data responsive to capturing the signature image.

22. A system according to claim 21 wherein the server provides access to the transaction document data over a network via a transmitted link.

23. A system according to claim 21 wherein the signature image capture component captures initials and a signature.

24. An electronic document comprising:
a parent document comprising a signature image capture component to capture a signature image received and identifying information specific to a transaction; and
a child document related to the parent document by the transaction, wherein the identifying information is automatically propagated from the parent document to the child document,
wherein the signature image capture component is executed to capture a received signature image, stores the signature image in association with the parent document, and locks at least a portion of the parent document responsive to capturing the signature image.

25. A method of executing a transaction document, the method comprising:
receiving a link to a transaction document object populated with transaction document data and incorporating a signature image capture component;
accessing the transaction document object via the link;
executing code of the signature image capture component on a client;
capturing a signature image via code of the signature image capture component of a party to the transaction document;
providing the signature image to be stored in association with the transaction document object to cause at least a portion of the transaction document data including the signature image to be locked.
